(19) United States
(12) Patent Application Publication
(10) Pub. No.: US 2015/0127424 A1
(43) Pub. Date: May 7, 2015

(54) SYSTEM AND METHOD FOR LINKING PANEL AND MEMBERSHIP DATA

(71) Applicant: WAL-MART STORES, INC., Bentonville, AR (US)

(72) Inventors: Cindy W. Casper, Bentonville, AR (US); Xiangmei Wu, Rogers, AR (US); Brian Schultz, Union, KY (US)

(21) Appl. No.: 14/070,666

(22) Filed: Nov. 4, 2013

(51) Int. Cl. G06Q 30/02; G06N 5/04

(52) U.S. Cl. CPC G06Q 30/0202; G06N 5/04
USPC 705/7.31

(57) ABSTRACT

A system is provided that allows for retail behavioral insights to be gained by linking research responses with transactional behavioral data. In one implementation, a method is provided to allow linking between customer research panel data with data collected by membership systems for particular users. For instance, behavioral data of a membership club account may be linked to a user's participation in a research panel. Such information may be useful for analyzing the user/consumer and predicting the behavior of the consumer and similar other consumers.

### BACKGROUND

There are many different methods for tracking behavior of consumers. For instance, there are systems for tracking electronic transactions, research panels, customer opinions and surveys, among other systems and data collect methods, both written and electronic, for gauging feedback from consumers.

### SUMMARY

According to one aspect of the present invention, it is realized that retail behavior insights may be gained with the ability to link research responses with transactional behavioral data related to consumers. According to one aspect, it is appreciated that it may be useful and particularly advantageous to allow linking from customer research panels to membership systems. In particular, it is appreciated that typically data collection methods from consumers are generally unconnected. More specifically, it is appreciated that it may be useful to link behavioral data associated with a membership account associated with a user to that user's participation on a research panel. Behavioral data of a membership account (e.g., a purchasing club such as, for example, the well-known Sam's Club, loyalty clubs capable of storing associated behavioral data, or similar accounts) generally includes transaction data, and if a method was provided to permit analysis of the consumer's attitudes towards products and services related to such transactions, such information may be useful for analyzing the consumer and predicting behavior of the consumer and similar other consumers.

To this end, tools may be provided to facilitate association of a membership account defined on a membership system with an identity of a subject within a research panel (e.g., as defined in a computer-based research panel database). Such tools may permit the user to “opt-in” to create an association between the two accounts. In one embodiment, an award may be provided within either system to encourage user participation. For instance, an existing research panel member may be provided a free membership (e.g., a limited membership normally requiring a membership fee) to a membership club in exchange for linking their research panel information to their membership account and behavioral data. Other incentives may be provided such as gift cards, discounts on purchases, preferred member statuses, or other types of incentives. Further, consumers already having membership accounts may be incented to provide their existing account data to the research panel, or may be recruited for participation on a research panel.

Once linking between accounts is performed, retail behavior insights may be gained by correlating transactional behavioral data with research panel responses. Further, predictive models may be used to better understand the “why's” behind consumer purchases, upgrades, and renewals. For instance, predictive models may be created that include demographic information (e.g., from a third party such as Experian), attitudinal data from primary research, and transactional data from membership account sales.

Further, because membership data and research panel response data may be linked, analyses may be performed that predict the responses of non-panel members in the membership database and non-member panelists. In one implementation, a database may be created that includes prior research responses among matched panelists to allow for imputing attitudes of non-panelists across a membership database. Also, by enabling such linking, certain research panelists may be targeted for research rather than targeting subjects within the general population of panelists.

Such linking provides many benefits, such as, for example, the ability to analyze survey data with membership account transactions. Also, such a system may allow consumers with membership accounts to participate in market research (which normally has higher participation rates). Further, consumers with membership accounts may be prescreened for participation in a panel based on their transactional information, increasing the quality of research panel information. For example, low incidence target groups may be identified based on membership account data. In addition, existing infrastructure may be leveraged without additional expense to gain more detailed insights into consumer behavior.

According to one aspect of the present invention, a system is provided for processing consumer-related data. The system comprises a membership system configured to collect and store transactional data associated with a membership account related to transactions performed by a user, a research panel system adapted to collect and store response data associated with one or more research subjects, wherein at least one of the research subjects includes the user, and a database that associates the membership account related to transactions performed by the user with an identity of a research subject defined within the research panel system.

According to one embodiment of the present invention, the system further comprises an interface that permits the user to perform an association operation between the membership account and the identity of the research subject. According to another embodiment of the present invention, the system further comprises an interface that provides an incentive to the user to provide information that associates their membership account with their identity within the research panel system. According to another embodiment of the present invention, the incentive includes at least one of a group of incentives comprising a gift card, a discount, a membership within the membership account, a preferred member status, a coupon, and an incentive associated with a membership account.

According to another embodiment of the present invention, the system further comprises a component that is adapted to identify a subset of users that have membership accounts within the membership system that are suitable for participation within a research panel. According to another embodiment of the present invention, the component identifies the subset of users based at least in part on transactions performed by those users using their membership accounts. According to another embodiment of the present invention, the system further comprises a component adapted to identify a subset of panel members defined within the research panel system suitable for obtaining membership accounts within the membership system that are suitable for participation within a research panel specific to members of a membership club.

According to another embodiment of the present invention, the system further comprises a component that is adapted to analyze the transactional data and response data. According to another embodiment of the present invention, the system further comprises a component adapted to predict behavior of the user based on the transactional and response data. According to another embodiment of the present invention, the system further comprises a component that receives third-party data, and provides the third-party data to the component that is adapted to analyze the transactional data and response data.

According to another aspect of the present invention, a method is provided for processing consumer-related data. The system comprises acts of collecting and storing, by a membership system, transactional data associated with a membership account related to transactions performed by a user, collecting and storing, by a research panel system, response data associated with one or more research subjects, wherein at least one of the research subjects includes the user, and associating in a database the membership account related to transactions performed by the user with an identity of a research subject defined within the research panel system.

According to one embodiment, the method further comprises an act of permitting the user to perform an association operation between the membership account and the identity of the research subject. According to another embodiment, the method further comprises an act of providing an incentive to the user to provide information that associates their membership account with their identity within the research panel system. According to one embodiment, the incentive includes at least one of a group of incentives comprising a gift card, a discount, a membership within the membership account, a preferred member status, a coupon, and an incentive associated with a membership account.

According to one embodiment, the method further comprises an act of automatically identifying a subset of users that have membership accounts within the membership system that are suitable for participation within a research panel. According to one embodiment, the method further comprises an act of identifying the subset of users based at least in part on transactions performed by those users using their membership accounts. According to one embodiment, the method further comprises an act of identifying a subset of panel members defined within the research panel system suitable for obtaining membership accounts within the membership system that are suitable for participation within a research panel specific to members of a membership club.

According to one embodiment, the method further comprises an act of analyzing the transactional data and response data. According to one embodiment, the method further comprises an act of predicting behavior of the user based on the transactional and response data. According to one embodiment, the method further comprises acts of receiving third-party data, and providing the third-party data to a component that is adapted to analyze the transactional data and response data.

Still other aspects, examples, and advantages of these exemplary aspects and examples, are discussed in detail below. Moreover, it is to be understood that both the foregoing information and the following detailed description are merely illustrative examples of various aspects and examples, and are intended to provide an overview or framework for understanding the nature and character of the claimed aspects and examples. Any example disclosed herein may be combined with any other example in any manner consistent with at least one of the objects, aims, and needs disclosed herein, and references to “an example,” “some examples,” “an alternate example,” “various examples,” “one example,” “at least one example,” “this and other examples” or the like are not necessarily mutually exclusive and are intended to indicate that a particular feature, structure, or characteristic described in connection with the example may be included in at least one example. The appearances of such terms herein are not necessarily all referring to the same example.

### BRIEF DESCRIPTION OF THE DRAWINGS

Various aspects of at least one example are discussed below with reference to the accompanying figures, which are not intended to be drawn to scale. The figures are included to provide an illustration and a further understanding of the various aspects and examples, and are incorporated in and constitute a part of this specification, but are not intended as a definition of the limits of a particular example. The drawings, together with the remainder of the specification, serve to explain principles and operations of the described and claimed aspects and examples. In the figures, each identical or nearly identical component that is illustrated in various figures is represented by a like numeral. For purposes of clarity, not every component may be labeled in every figure. In the figures:

FIG. 1 is a block diagram showing a system for linking membership system and a research panel system according to various aspects of the present invention;

FIG. 2 shows an embodiment of a method for linking membership accounts and research panel data according to various embodiments of the present invention;

FIG. 3 shows another embodiment of a method for linking membership accounts and research panel data according to various embodiments of the present invention;

FIGS. 4A-4C show various example implementations for linking membership accounts and research panel data according to various embodiments of the present invention;

FIG. 5 shows an example process for linking a current panel member to a membership club account according to one embodiment of the present invention;

FIG. 6 shows an example process for linking a non-panel member to a non-membership club member through a membership club website according to one embodiment of the present invention;

FIG. 7 shows an example process for linking an existing panel member's data to their existing membership club account according to one embodiment of the present invention;

FIG. 8 shows an example computer system with which various aspects of the invention may be practiced; and

FIG. 9 shows an example storage system capable of implementing various aspects of the present invention.

### DETAILED DESCRIPTION

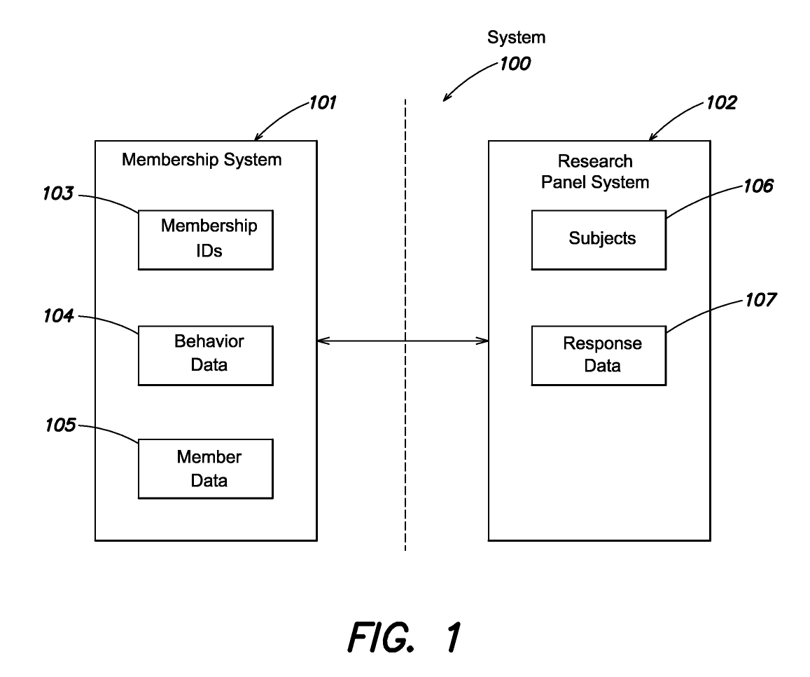

FIG. 1 shows a block diagram of a system 100 suitable for implementing various aspects of the present invention. In particular, according to one embodiment, FIG. 1 shows a distributed computer system 100 that includes a membership system 101 and a research panel system 102 capable of implementing various aspects of the present invention. Membership system 101 may be for example, a computer system that stores one or more membership IDs (e.g., IDs 103) along with their associated member data (e.g., member data 105) and behavioral data (e.g., data 104). For instance, a membership club such as Sam's Club may have a system that is adapted to store member information along with their transactional information such as visitation data, purchasing data, items bought, among other information.

Research panel system 102 may be for example, a computer system that stores response data (e.g., response data 107) relating to one or more subjects (e.g., subjects 106). Such response data may be stored in one or more computer systems associated with a research provider (e.g., a company that provides market panel research to one or more participating companies). Such response data may include, for example, consumers' attitudes towards products and services.

According to one embodiment, it is appreciated that some membership databases are fairly large and thus such databases may serve as a basis for aligning attitudinal survey results with behavioral transactional data within the membership database. Thus, a membership database may be used to create or add to a research panel. In some cases, membership data may be used to prescreen and create a targeted panel.

According to one embodiment, current research panelists may be invited to become part of a membership account-related panel. Such current research panelists may already have an account defined within the membership system or may be invited to create a new account within the membership system. Alternatively, people that have membership accounts may be invited to join an established research panel, or may be invited to a creation of an entirely new research panel (e.g., created from membership account holders meeting certain criteria). In this way, panel research data such as attitudinal data towards products or services may be correlated with transactional data from members. Further, other third-party data may be used to gain further insight regarding consumers, such as for example, demographic information that to can be received from a number of third-party sources (e.g., Experian).

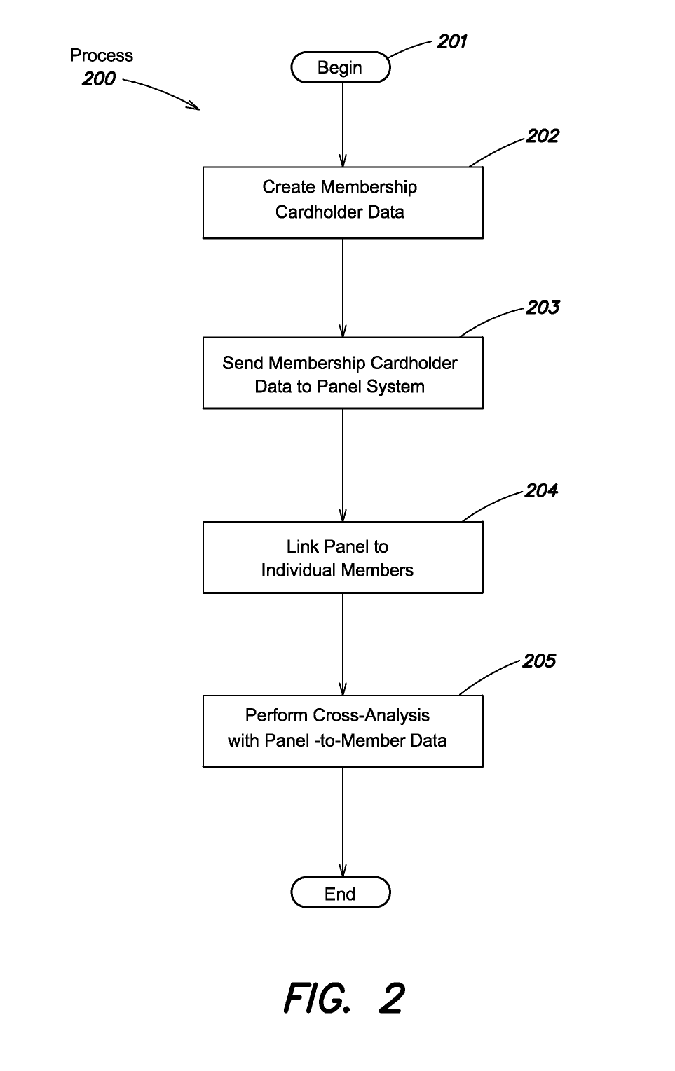

FIG. 2 shows an embodiment of a method for linking membership accounts and research panel data according to various embodiments of the present invention. At block 201, process 200 begins. At block 202, a computer system (e.g., a membership system) creates membership data. For instance, a particular member may be assigned a membership ID, and may be provided a membership card through which transactions may be performed. Transactions are stored within the membership system based on (or indexed by) the assigned membership ID.

At block 203, the membership system may send membership cardholder data to a research panel system. Alternatively, research panel data may be sent to and stored within the membership system. However, it is appreciated that a research panel system may include one or more tools for analyzing response data, and therefore additional transaction data may be imported and analyzed accordingly by existing tools.

According to one embodiment, a panel and its subjects may be linked to individual membership accounts and their associated data (e.g., at block 204). For instance, a particular subject identified within the research panel system (e.g., system 102) a be linked with an individual member defined within the membership system (e.g., by his/her membership ID). Such an association may be made within a database of the membership system and/or research panel system (e.g., as defined within one or more databases), may be provided as a separate database, file, or other storage construct, or may by imported into a third-party system. After an association is made between panel subjects and members, cross analysis may be performed using panel-to-member data (e.g., at block 205). At block 206, process 200 ends.

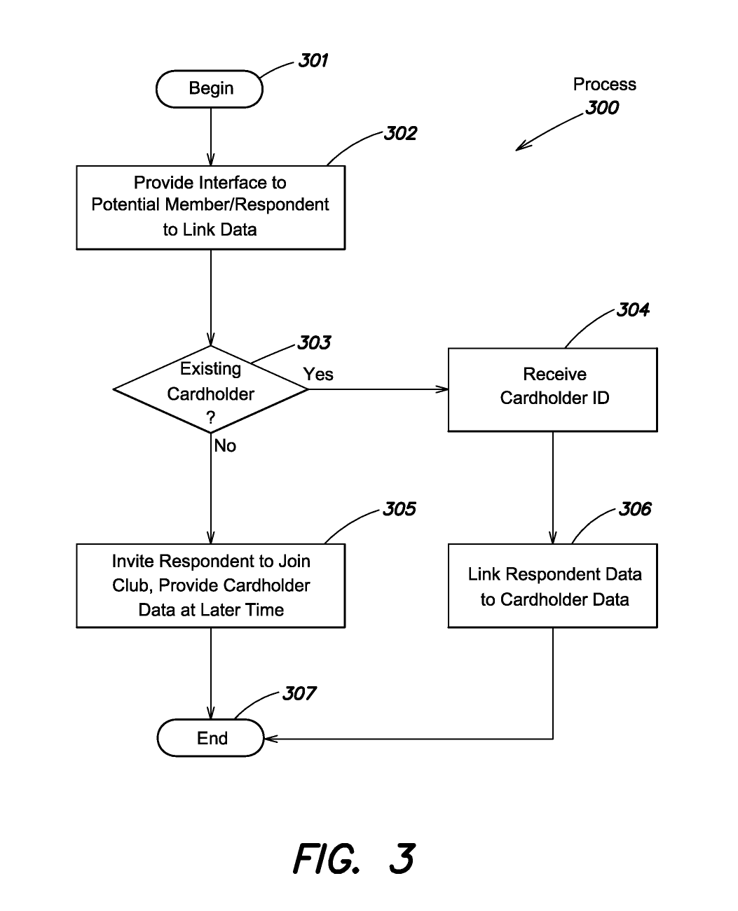

FIG. 3 shows another embodiment of a method for linking membership account and research panel data according to various embodiments of the present invention. At block 301, process 300 begins. At block 302, and interface is provided to potential members/respondents to link their data. At block 303 is determined whether the subject is an existing cardholder (e.g., a member is defined within the membership system). If so, the system is configured to receive a cardholder ID or membership ID at block 304. For instance, a user may provide a membership ID within a website interface, via a scanner, a mobile application, camera or other method of providing identifying information. At block 306, the system links respondent data from a research panel system to cardholder data associated with a membership system.

If the subject is not an existing cardholder, the system may invite the respondent to join a club or other membership entity at block 305. Optionally, the respondent may provide cardholder information at a later time, at which point an association may be made between respondent data and cardholder data. At block 307, process 300 ends.

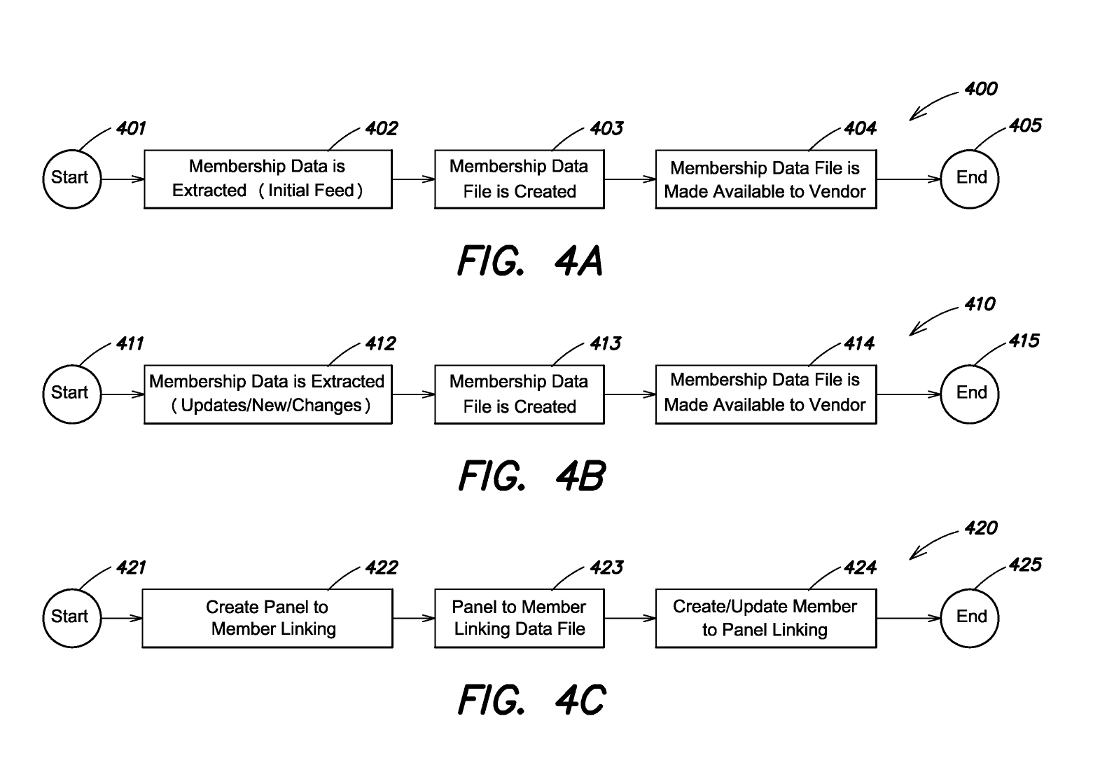

FIGS. 4A-4C show various examples of limitations for linking membership accounts to research panel data according to various embodiments of the present invention. For instance, various procedures may be provided that allow for creation and linking of particular data. For instance, FIG. 4A shows a process 400 where membership data is provided to a third-party such as a research panel provider. At block 401, process 400 begins. At block 402 membership data including membership IDs and transactional data is extracted from membership database. The block 403, a membership data file is created, and that membership datafile is made available to a vendor (e.g., a research panel provider) at block 404. At block 405, process 400 ends.

FIG. 4B shows a process 410 where updated membership data is provided to third-party provider. At block 411, process 410 begins. At block 412, membership data including any updates or new changes is extracted from the membership database. For instance, membership data may be updated in real-time using transactions performed within one or more member stores, and updates to the database may be provided to the research panel provider on a periodic basis. At block 413, the membership datafile is created and is made available to the vendor at block 414. At block 415, process 410 ends.

FIG. 4C shows a process 420 where linking is performed between a research panel database and a membership system database according to one embodiment of the present invention. At block 421, process 420 begins. At block 422, the computer system creates a panel to member linking. For instance, a membership database may store and track linking from members to panel subjects based on membership IDs within the membership database. At block 423, a system (e.g., a membership system) may create a panel to member linking data file that includes an association between membership IDs and subject information within the research panel database. Periodically, as members join and associations to panels are made, there may be a need for periodically updating the associations. Therefore, at block 424, the system may create/update member to panel linking as necessary as the database changes within real-time. At block 425, process 420 ends.

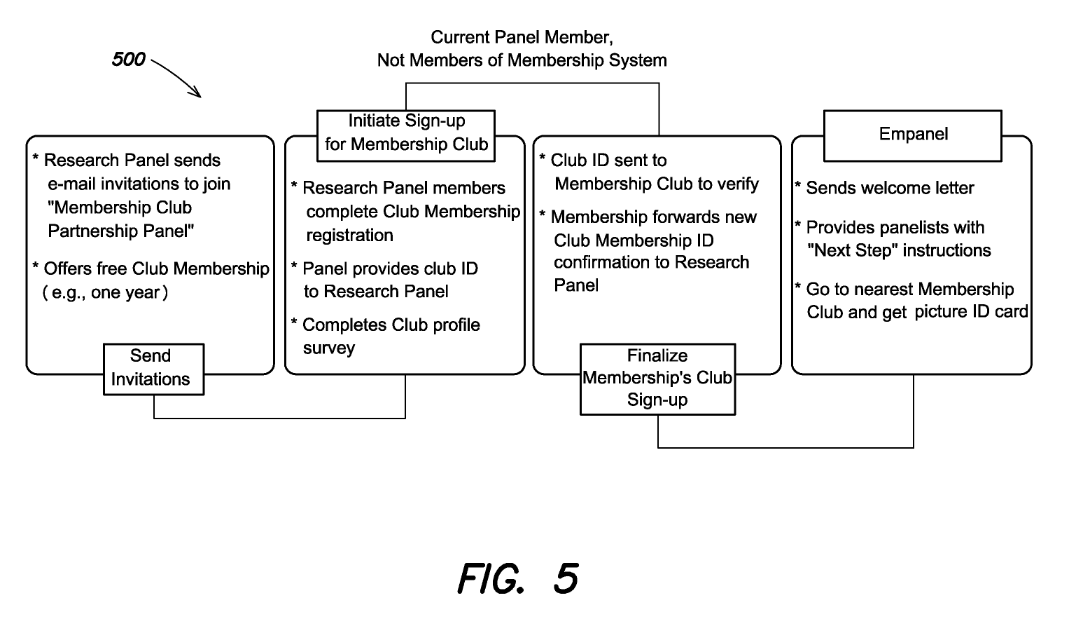

FIG. 5 shows an example process 500 for linking a current panel member to a membership club account according to one embodiment of the present invention. For instance, there may be one or more use cases that permit easy association between research panel members and membership club account. For instance as shown in FIG. 5, for current panel members that are not currently members of a membership system, one or more processes may be provided that facilitates such research panel members to join the membership system.

For instance, a research panel system may send email invitations to join a “Membership Club Partnership Panel” that may include, for example, a research panel made up of subjects having membership accounts within the membership system. To encourage participation by research panel members, an incentive may be provided. For instance, the research panel invitation may provide a free membership club account to a participating research panel subject. For instance, in one implementation, a membership club account may have some monetary value and therefore, the subject may be incentive to join. Other incentives may be provided (and targeted) to particular subjects as necessary to encourage participation.

According to one embodiment, a research panel system sends one or more invitations (e.g., via email) to one or more research panel members. For instance, according to one embodiment, the email invitation may include a control that initiates a sign up for a membership club. For instance, a link may be provided to an interface (e.g., a website interface) that permits research panel members to complete a club membership registration. In one embodiment, the club membership registration process determines a membership club ID which is provided to the research panel system. Also, according to one embodiment, the panel member may be requested to complete a club profile survey where additional information may be collected.

To finalize a membership club sign-up, a membership club ID the recent to a membership club system for verification. In one embodiment, a number ship system forwards a new club membership ID confirmation to a research panel system, and an association is made between the membership club ID and a panel member identification. Panel member identification may be, for example, a unique identification number for a panel subject. After an association is made, that panel member may now contribute towards information that can be linked back to a membership club identifier. For instance, an empanel process may be performed that welcomes the panel member to the specialized panel, provides panelists with next step instructions, and performs any other necessary functions with the panel. Further, the system may instruct the panel member to complete any other additional requirements with the membership club, such as obtaining a picture ID at a local membership club location, among other actions.

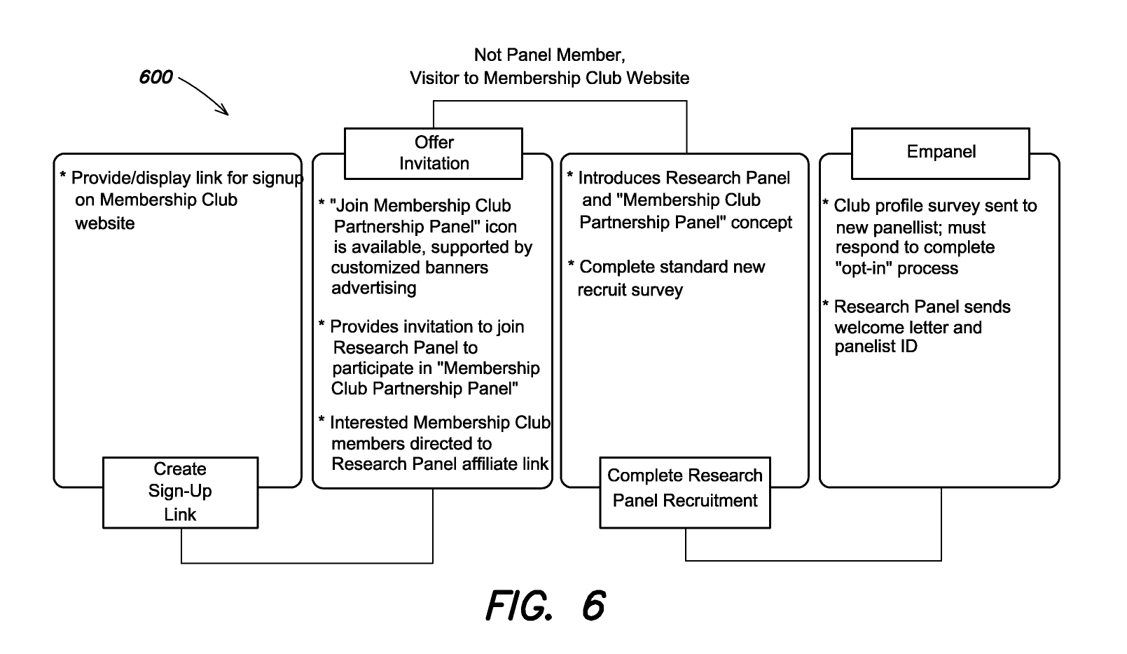

FIG. 6 shows an example process 600 for linking a non-panel member to a non-membership club member through a membership club website according to one embodiment of the present invention. In one example use case, a sign-up link may be provided and displayed to the user that offers an invitation to sign up to a membership club partnership panel. For instance, a membership club website may provide such a display link.

In one embodiment, a “Join Membership Club Partnership Panel” icon may be displayed to the user (e.g., within a main interface, within a customized banner or advertisement) that when selected by the user, allows a visitor to a membership club website to join a research panel. For example, the system may provide an invitation to join a research panel by participating in a “Membership Club Partnership Panel” including panel members that are also membership club participants. For instance, interested membership club members may be directed to the research panel affiliate link to complete a research panel recruitment process.

For example, a website might be provided that introduces the research panel and the concepts related to a “Membership Club Partnership Panel.” Further, the website may perform other data collection operations such as, for example, requiring that the new panel member complete a standard new recruit survey. When the research panel sign up is completed, empanel operations may be performed. In one implementation, the club profile survey may be sent to a new panelist, and that panelist must respond to complete an “opt-in” process for sharing their membership data with the panel provider. Further, the research panel may send a welcome letter to the new panel member and may assign a panelist ID. This panelist ID may be correlated to a membership ID defined in a membership system (e.g., system 101).

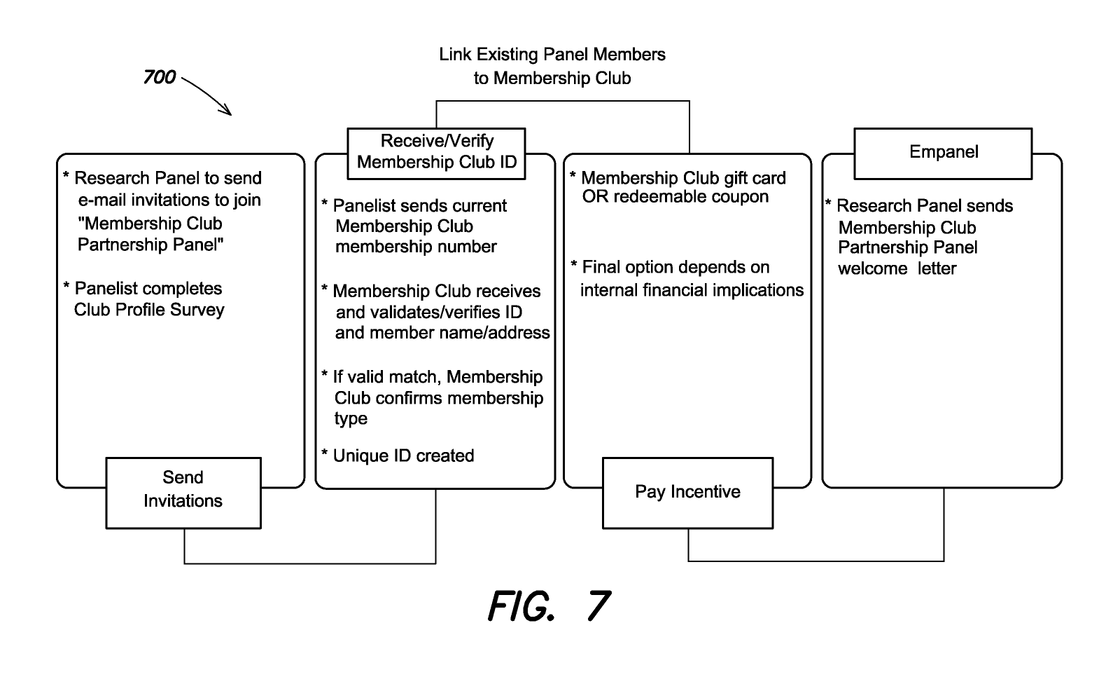

FIG. 7 shows an example process 700 for linking an existing panel member's data to their existing membership club account according to one embodiment of the present invention. For example, panel members that participate in a general research panel may be invited to join a particular “Membership Club Partnership Panel” that includes panel members that are also membership club participants. For instance, a research panel system may send email invitations to join the “Membership Club Partnership Panel.” In such a case, an existing panelist may be invited to complete a membership club profile survey. Such invitations may be sent for example, by one or more systems associated with the research panel provider.

After receiving an invitation, a panelist may send their current membership club membership number or ID to a membership system. A membership club system may receive and validate/verify a particular membership ID and/or member name and any other associated information (e.g., an email address). If a valid match is determined, a membership club system may confirm a particular membership type. Furthermore, a unique ID may be created for the panelist. To encourage participation, the existing panel member may be provided one or more incentives. For instance, the panelist member may be provided a membership club gift card, coupon, discount, free membership, or any other type of incentive in exchange for providing additional information. For instance, in one embodiment, the final incentive option may depend on some internal financial implications. For example, depending on the research required, different financial incentives may be offered depending on the entity needing the information. For example, certain studies or panels may be sponsored and incentivized by one or more third party providers.

After an incentive is provided and accepted, an association may be made between the membership club identity of the user and the panel identity, and functions associated with the panel may be performed. For instance, a “Membership Club Partnership Panel” welcome letter/email may be sent to the panel member with instructions on their participation in the panel. As discussed, the “Membership Club Partnership Panel” includes panel members that are also membership club participants.

### Example Computer Implementations

Processes described above are merely illustrative embodiments of systems that may be used to perform linking between membership system data and research panel data. Such illustrative embodiments are not intended to limit the scope of the present invention, as any of numerous other implementations for performing the invention. None of the claims set forth below are intended to be limited to any particular implementation of membership and panel systems, unless such claim includes a limitation explicitly reciting a particular implementation.

Processes and methods associated with various embodiments, acts thereof and various embodiments and variations of these methods and acts, individually or in combination, may be defined by computer-readable signals tangibly embodied on a computer-readable medium, for example, a non-volatile recording medium, an integrated circuit memory element, or a combination thereof. According to one embodiment, the computer-readable medium may be non-transitory in that the computer-executable instructions may be stored permanently or semi-permanently on the medium. Such signals may define instructions, for example, as part of one or more programs, that, as a result of being executed by a computer, instruct the computer to perform one or more of the methods or acts described herein, and/or various embodiments, variations and combinations thereof. Such instructions may be written in any of a plurality of programming languages, for example, Java, Visual Basic, C, C#, or C++, Fortran, Pascal, Eiffel, Basic, COBOL, etc., or any of a variety of combinations thereof. The computer-readable medium on which such instructions are stored may reside on one or more of the components of a general-purpose computer described above, and may be distributed across one or more of such components.

The computer-readable medium may be transportable such that the instructions stored thereon can be loaded onto any computer system resource to implement the aspects of the present invention discussed herein. In addition, it should be appreciated that the instructions stored on the computer-readable medium, described above, are not limited to instructions embodied as part of an application program running on a host computer. Rather, the instructions may be embodied as any type of computer code (e.g., software or microcode) that can be employed to program a processor to implement the above-discussed aspects of the present invention.

Various embodiments according to the invention may be implemented on one or more computer systems. These computer systems may be, for example, general-purpose computers such as those based on Intel PENTIUM-type processor, Motorola PowerPC, Sun UltraSPARC, Hewlett-Packard PA-RISC processors, ARM Cortex processor, Qualcomm Scorpion processor, or any other type of processor. It should be appreciated that one or more of any type computer system may be used to partially or fully automate linking between membership system data and research panel data according to various embodiments of the invention. Further, the system may be located on a single computer or may be distributed among a plurality of computers attached by a communications network.

The computer system may include specially-programmed, special-purpose hardware, for example, an application-specific integrated circuit (ASIC). Aspects of the invention may be implemented in software, hardware or firmware, or any combination thereof. Further, such methods, acts, systems, system elements and components thereof may be implemented as part of the computer system described above or as an independent component.

A computer system may be a general-purpose computer system that is programmable using a high-level computer programming language. Computer system may be also implemented using specially programmed, special purpose hardware. In a computer system there may be a processor that is typically a commercially available processor such as the well-known Pentium class processor available from the Intel Corporation. Many other processors are available. Such a processor usually executes an operating system which may be, for example, the Windows NT, Windows 2000 (Windows ME), Windows XP, Windows Vista, Windows 7, or Windows 8 operating systems available from the Microsoft Corporation, MAC OS X Snow Leopard, MAC OS X Lion operating systems available from Apple Computer, the Solaris Operating System available from Sun Microsystems, iOS, Blackberry OS, Windows 7 Mobile or Android OS operating systems, or UNIX available from various sources. Many other operating systems may be used.

Some aspects of the invention may be implemented as distributed application components that may be executed on a number of different types of systems coupled over a computer network. Some components may be located and executed on mobile devices, servers, tablets, or other system types. Other components of a distributed system may also be used, such as databases (e.g., the well-known mongoDB database available from 10 gen, Inc.), cloud services, or other component types.

The processor and operating system together define a computer platform for which application programs in high-level programming languages are written. It should be understood that the invention is not limited to a particular computer system platform, processor, operating system, or network. Further, it should be appreciated that multiple computer platform types may be used in a distributed computer system that implement various aspects of the present invention. Also, it should be apparent to those skilled in the art that the present invention is not limited to a specific programming language or computer system. Further, it should be appreciated that other appropriate programming languages and other appropriate computer systems could also be used.

One or more portions of the computer system may be distributed across one or more computer systems coupled to a communications network. These computer systems also may be general-purpose computer systems. For example, various aspects of the invention may be distributed among one or more computer systems configured to provide a service (e.g., servers) to one or more client computers, or to perform an overall task as part of a distributed system. For example, various aspects of the invention may be performed on a client-server system that includes components distributed among one or more server systems that perform various functions according to various embodiments of the invention. These components may be executable, intermediate (e.g., IL) or interpreted (e.g., Java) code which communicate over a communication network (e.g., the Internet) using a communication protocol (e.g., TCP/IP). Certain aspects of the present invention may also be implemented on a cloud-based computer system (e.g., the EC2 cloud-based computing platform provided by Amazon.com), a distributed computer network including clients and servers, or any combination of systems.

It should be appreciated that the invention is not limited to executing on any particular system or group of systems. Also, it should be appreciated that the invention is not limited to any particular distributed architecture, network, or communication protocol.

Various embodiments of the present invention may be programmed using an object-oriented programming language, such as SmallTalk, Java, C++, Ada, or C# (C-Sharp). Other object-oriented programming languages may also be used. Alternatively, functional, scripting, and/or logical programming languages may be used. Various aspects of the invention may be implemented in a non-programmed environment (e.g., documents created in HTML, XML or other format that, when viewed in a window of a browser program, render aspects of a graphical-user interface (GUI) or perform other functions). Various aspects of the invention may be implemented as programmed or non-programmed elements, or any combination thereof.

Further, on each of the one or more computer systems that include one or more components of distributed computer system 100, each of the components may reside in one or more locations on the system. For example, different portions of the components of system 100 may reside in different areas of memory (e.g., RAM, ROM, disk, etc.) on one or more computer systems. Each of such one or more computer systems may include, among other components, a plurality of known components such as one or more processors, a memory system, a disk storage system, one or more network interfaces, and one or more busses or other internal communication links interconnecting the various components.

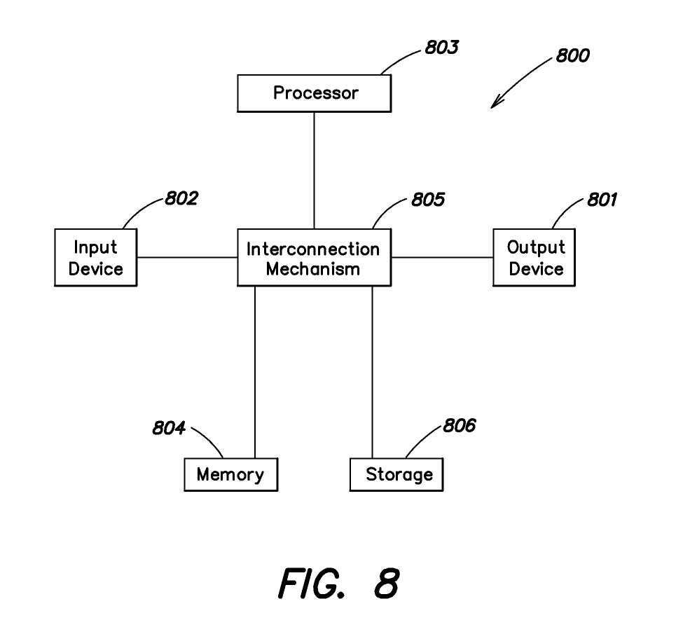

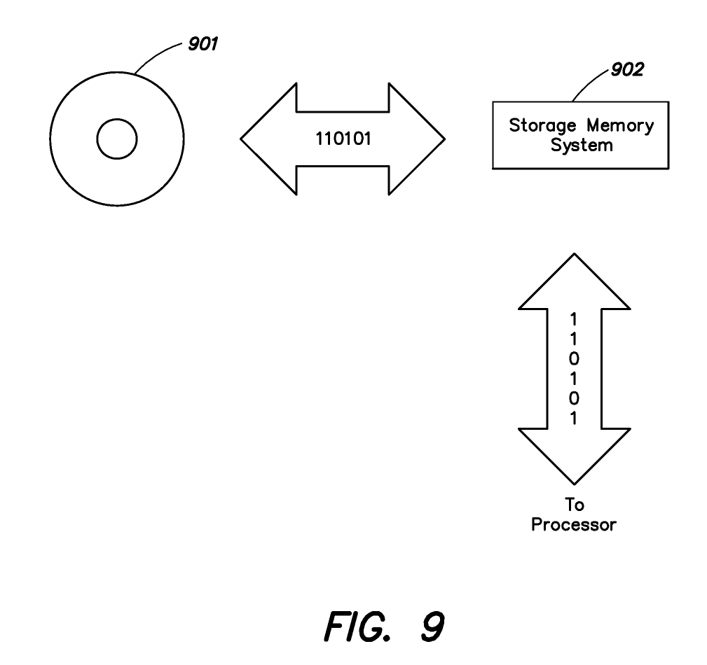

Any number of systems of system 100 may be implemented on a computer system described below in relation to FIGS. 8 and 9. In particular, FIG. 8 shows an example computer system 800 used to implement various aspects. FIG. 9 shows an example storage system that may be used.

System 800 is merely an illustrative embodiment of a computer system suitable for implementing various aspects of the invention. Such an illustrative embodiment is not intended to limit the scope of the invention, as any of numerous other implementations of the system, for example, are possible and are intended to fall within the scope of the invention. For example, a virtual computing platform may be used. None of the claims set forth below are intended to be limited to any particular implementation of the system unless such claim includes a limitation explicitly reciting a particular implementation.

For example, various aspects of the invention may be implemented as specialized software executing in a general-purpose computer system 800 such as that shown by way of example in FIG. 8. The computer system 800 may include a processor 803 connected to one or more memory devices 804, such as a disk drive, memory, or other device for storing data. Memory 804 is typically used for storing programs and data during operation of the computer system 800. Components of computer system 800 may be coupled by an interconnection mechanism 805, which may include one or more busses (e.g., between components that are integrated within a same machine) and/or a network (e.g., between components that reside on separate discrete machines). The interconnection mechanism 805 enables communications (e.g., data, instructions) to be exchanged between system components of system 800. Computer system 800 also includes one or more input devices 802, for example, a keyboard, mouse, scanner, trackball, microphone, touch screen, and one or more output devices 801, for example, a printing device, display screen, and/or speaker. The system may also include any specialized components depending on the application, including any barcode reader, magnetic stripe reader, receipt printer, hand-held or fixed scanners, pin entry devices (PED), or other device types. In addition, computer system 800 may contain one or more interfaces (not shown) that connect computer system 800 to a communication network (in addition or as an alternative to the interconnection mechanism 805).

The storage system 906, shown in greater detail in FIG. 9, typically includes a computer readable and writeable nonvolatile recording medium 901 in which signals are stored that define a program to be executed by the processor or information stored on or in the medium 901 to be processed by the program. The medium may, for example, be a disk or flash memory. Typically, in operation, the processor causes data to be read from the nonvolatile recording medium 901 into another memory 902 that allows for faster access to the information by the processor than does the medium 901. This memory 902 is typically a volatile, random access memory such as a dynamic random access memory (DRAM) or static memory (SRAM). It may be located in storage system 806, as shown, or in memory system 804. The processor 803 generally manipulates the data within the integrated circuit memory 804, 902 and then copies the data to the medium 901 after processing is completed. A variety of mechanisms are known for managing data movement between the medium 901 and the integrated circuit memory element 804, 902, and the invention is not limited thereto. The invention is not limited to a particular memory system 804 or storage system 806.

The computer system may include specially-programmed, special-purpose hardware, for example, an application-specific integrated circuit (ASIC). Aspects of the invention may be implemented in software, hardware or firmware, or any combination thereof. Further, such methods, acts, systems, system elements and components thereof may be implemented as part of the computer system described above or as an independent component.

Although computer system 800 is shown by way of example as one type of computer system upon which various aspects of the invention may be practiced, it should be appreciated that aspects of the invention are not limited to being implemented on the computer system as shown in FIG. 8. Various aspects of the invention may be practiced on one or more computers having a different architecture or components that that shown in FIG. 8.

Computer system 800 may be a general-purpose computer system that is programmable using a high-level computer programming language. Computer system 800 may be also implemented using specially programmed, special purpose hardware. In computer system 800, processor 803 is typically a commercially available processor such as the well-known Pentium, Core, Core Vpro, Xeon, or Itanium class processors available from the Intel Corporation. Many other processors are available. Such a processor usually executes an operating system which may be, for example, the Windows NT, Windows 2000 (Windows ME), Windows XP, Windows Vista, Windows 7 or Windows 8 operating systems available from the Microsoft Corporation, MAC OS Snow Leopard, MAC OS X Lion operating systems available from Apple Computer, the Solaris Operating System available from Sun Microsystems, iOS, Blackberry OS, Windows 7 or 8 Mobile or Android OS operating systems, or UNIX available from various sources. Many other operating systems may be used.

The processor and operating system together define a computer platform for which application programs in high-level programming languages are written. It should be understood that the invention is not limited to a particular computer system platform, processor, operating system, or network. Also, it should be apparent to those skilled in the art that the present invention is not limited to a specific programming language or computer system. Further, it should be appreciated that other appropriate programming languages and other appropriate computer systems could also be used.

One or more portions of the computer system may be distributed across one or more computer systems (not shown) coupled to a communications network. These computer systems also may be general-purpose computer systems. For example, various aspects of the invention may be distributed among one or more computer systems configured to provide a service (e.g., servers) to one or more client computers, or to perform an overall task as part of a distributed system. For example, various aspects of the invention may be performed on a client-server system that includes components distributed among one or more server systems that perform various functions according to various embodiments of the invention. These components may be executable, intermediate (e.g., IL) or interpreted (e.g., Java) code which communicate over a communication network (e.g., the Internet) using a communication protocol (e.g., TCP/IP).

It should be appreciated that the invention is not limited to executing on any particular system or group of systems. Also, it should be appreciated that the invention is not limited to any particular distributed architecture, network, or communication protocol.

Various embodiments of the present invention may be programmed using an object-oriented programming language, such as SmallTalk, Java, C++, Ada, or C# (C-Sharp). Other object-oriented programming languages may also be used. Alternatively, functional, scripting, and/or logical programming languages may be used. Various aspects of the invention may be implemented in a non-programmed environment (e.g., documents created in HTML, XML or other format that, when viewed in a window of a browser program, render aspects of a graphical-user interface (GUI) or perform other functions). Various aspects of the invention may be implemented using various Internet technologies such as, for example, the well-known Common Gateway Interface (CGI) script, PHP Hyper-text Preprocessor (PHP), Active Server Pages (ASP), HyperText Markup Language (HTML), Extensible Markup Language (XML), Java, JavaScript, Asynchronous JavaScript and XML (AJAX), Flash, and other programming methods. Further, various aspects of the present invention may be implemented in a cloud-based computing platform, such as the well-known EC2 platform available commercially from Amazon.com, Seattle, Wash., among others. Various aspects of the invention may be implemented as programmed or non-programmed elements, or any combination thereof.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A system for processing consumer-related data, the system comprising:
a membership system configured to collect and store transactional data associated with a membership account related to transactions performed by a user;
a research panel system adapted to collect and store response data associated with one or more research subjects, wherein at least one of the research subjects includes the user; and
a database that associates the membership account related to transactions performed by the user with an identity of a research subject defined within the research panel system.

2. The system according to claim 1, further comprising an interface that permits the user to perform an association operation between the membership account and the identity of the research subject.

3. The system according to claim 1, further comprising an interface that provides an incentive to the user to provide information that associates their membership account with their identity within the research panel system.

4. The system according to claim 3, wherein the incentive includes at least one of a group of incentives comprising:
a gift card;
a discount;
a membership within the membership account;
a preferred member status;
a coupon; and
an incentive associated with a membership account.

5. The system according to claim 1, further comprising a component that is configured to identify a subset of users that have membership accounts within the membership system that are suitable for participation within a research panel.

6. The system according to claim 5, wherein the component identifies the subset of users based at least in part on transactions performed by those users using their membership accounts.

7. The system according to claim 1, further comprising a component adapted to identify a subset of panel members defined within the research panel system suitable for obtaining membership accounts within the membership system that are suitable for participation within a research panel specific to members of a membership club.

8. The system according to claim 1, further comprising a component that is adapted to analyze the transactional data and response data.

9. The system according to claim 8, further comprising a component adapted to predict behavior of the user based on the transactional and response data.

10. The system according to claim 8, further comprising a component that receives third-party data, and provides the third-party data to the component that is adapted to analyze the transactional data and response data.

11. A method for processing consumer-related data, the system comprising acts of:
collecting and storing, by a membership system, transactional data associated with a membership account related to transactions performed by a user;
collecting and storing, by a research panel system, response data associated with one or more research subjects, wherein at least one of the research subjects includes the user; and
associating in a database the membership account related to transactions performed by the user with an identity of a research subject defined within the research panel system.

12. The method according to claim 11, further comprising an act of permitting the user to perform an association operation between the membership account and the identity of the research subject.

13. The method according to claim 11, further comprising an act of providing an incentive to the user to provide information that associates their membership account with their identity within the research panel system.

14. The method according to claim 13, wherein the incentive includes at least one of a group of incentives comprising:
a gift card;
a discount;
a membership within the membership account;
a preferred member status;
a coupon; and
an incentive associated with a membership account.

15. The method according to claim 11, further comprising an act of automatically identifying a subset of users that have membership accounts within the membership system that are suitable for participation within a research panel.

16. The method according to claim 15, further comprising an act of identifying the subset of users based at least in part on transactions performed by those users using their membership accounts.

17. The method according to claim 11, further comprising an act of identifying a subset of panel members defined within the research panel system suitable for obtaining membership accounts within the membership system that are suitable for participation within a research panel specific to members of a membership club.

18. The method according to claim 11, further comprising an act of analyzing the transactional data and response data.

19. The system according to claim 18, further comprising an act of predicting behavior of the user based on the transactional and response data.

20. The method according to claim 18, further comprising acts of receiving third-party data, and providing the third-party data to a component that is adapted to analyze the transactional data and response data.
